(19) United States
(12) Patent Application Publication
(10) Pub. No.: US 2007/0205709 A1
(43) Pub. Date: Sep. 6, 2007

(54) Image display device

(75) Inventor: Kenji Kato, Mobara (JP)

Correspondence Address: MILBANK, TWEED, HADLEY & MCCLOY, 1 CHASE MANHATTAN PLAZA, NEW YORK, NY, 10005-1413, US

(73) Assignee: Hitachi Displays, Ltd.

(21) Appl. No.: 11/711,441

(22) Filed: Feb. 27, 2007

(30) Foreign Application Priority Data
Mar. 1, 2006 (JP) 2006-054704

(51) Int. Cl. H01J 63/04; H01J 1/62

(52) U.S. Cl. 313/495

(57) ABSTRACT

A back substrate includes a getter room which is communicated with a vacuum envelope, and a getter assembly is arranged in the inside of the getter room. The getter assembly is provided with a getter support which holds and heats a non-volatile getter and a pair of electrodes which is respectively connected to both end portions of the getter support. Another-end sides of the pair of electrodes pass through a room member and are pulled out to the outside. The present invention provides an image display device which can facilitate the activation of a getter by fixedly mounting a non-volatile getter and, at the same time, can obtain the high degree of vacuum by the effective activation.

### BACKGROUND OF THE INVENTION

1. Field of the Invention

The present invention relates to an image display device, and more particularly to an image display device in which a non-volatile getter device is provided to a vacuum envelope in which a back substrate having electron emission sources formed thereon and a face substrate having an anode and phosphors formed thereon are arranged to face each other.

2. Description of the Related Art

As an image display device which performs a display by allowing electrons to impinge on a phosphor screen thus emitting light, there has been known a thin CRT (Thin Cathode Ray Tube) which is represented by a field emission type image display device (Field Emission Display) having field emission type electron sources or a surface conduction type image display device having surface conduction type electron sources, a cathode ray tube, and the like, for example. It is necessary for such an image display device to hold the inside of an envelope thereof in a highly vacuum state to facilitate the movement of electrons.

In the conventional image display device, a getter is arranged on the same surface as a surface of the back substrate on which electron sources are formed. When the getter is formed on the same surface on which the electron sources are formed, it is necessary to reduce an area of a display region portion or it is necessary to increase only an area where the getter is formed. Further, there exists a drawback that, when the getter is a volatile getter, in arranging the getter in the inside of an active environment (a space in which the electron sources are formed), the electron emission portions of the electron sources are covered with a getter film and hence, the electron emission ability is reduced.

JP-A-2003-528422 (patent document 1) discloses a technique which can cope with the above-mentioned problem by forming a getter room joined to the back surface side of the display device.

The above-mentioned patent document 1 discloses an image display device of the structure which prevents electron emission portions from being exposed to a getter by arranging a non-volatile getter in an auxiliary chamber (getter room). However, in the image display device having such constitution, tasks on acquisition of the getter mounting position and the maintenance of high degree of vacuum which can easily activate the non-volatile getter are not taken into consideration at all.

Further, the non-volatile getter which is housed in a housing is directly mounted on a getter room member formed of glass and hence, when the non-volatile getter is heated using a high-frequency heating device, the housing is also simultaneously heated. Here, there arises a drawback that a thermal expansion quantity of the housing and a thermal expansion quantity of the getter room differ from each other and hence, a crack occurs at a mounting portion between the housing and the getter room whereby the display property of the image display device is deteriorated.

There has been also known a display device in which a getter room is arranged on a portion of a panel surface for improving the degree of vacuum and a volatile getter and a non-volatile getter are arranged in the inside of the getter room and are activated using a high-frequency heating device. With the structure of the display device, it is possible to effectively activate the non-volatile getter a plurality of times. However, with the activation method using the high-frequency heating device, it is difficult to acquire the proper getter mounting position and the activation of the getter in an exhaust gas.

Further, as a method for fixing the getter, the getter is welded to a stainless-steel-made support and the support is fixed by sandwiching between the face substrate or the back substrate and a frame body. However, there arises a drawback that it is necessary to reduce a plate thickness of the support due to the adoption of frit welding and hence, the support is easily deformed and the getter mounting position becomes unstable or the like.

### SUMMARY OF THE INVENTION

The present invention has been made to overcome the above-mentioned drawbacks of the related art, and it is an object of the present invention to provide an image display device which can facilitate the activation of a getter by fixedly mounting a non-volatile getter and, at the same time, can obtain the high degree of vacuum by the effective activation.

An image display device according to the present invention includes a back substrate which forms a plurality of electron emission sources thereon and a face substrate which forms an anode and phosphors on a surface thereof which faces an electron emission source forming surface of the back substrate. The electron emission source forming surface of the back substrate and the anode forming surface of the face substrate are arranged to face each other. A support frame is arranged between the face substrate and the back substrate in a state that the support frame surrounds an anode forming region of the face substrate and an electron emission source forming region of the back substrate thus hermetically sealing the anode forming region and the electron emission source forming region. Due to such a constitution, a vacuum envelope is formed. A gas in the inside of a space defined by the back substrate, the face substrate and the support frame is discharged. A room member which forms a getter room communicated with the vacuum envelope is joined to an outer surface of the back substrate by way of a sealing member, and a getter assembly is arranged in the inside of the getter room. The getter assembly includes a non-volatile getter material, a getter support which holds and fixes the non-volatile getter material and heats the non-volatile getter material, and a pair of electrodes having one end side thereof connected to both end portions of the getter support and the other side thereof pulled out to the outside through the room member. The getter support is supported and fixed between the pair of electrodes thus holding and fixing the getter in the inside of the getter room. Due to the above-mentioned constitution, it is possible to overcome the drawbacks of the related art.

Further, in another image display device according to the present invention, in the above-mentioned constitution, the getter room may preferably be communicated with the inside of the vacuum envelope via a through hole formed in the back substrate.

Further, in still another image display device according to the present invention, in the above-mentioned constitution, an exhaust hole may preferably be formed in a bottom surface portion of the room member and an exhaust pipe may preferably be connected to the exhaust hole.

Further, in another image display device according to the present invention, in the above-mentioned constitution, the non-volatile getter material may preferably be arranged between an outer surface of the back substrate and a surface of the room member which is arranged to face the outer surface of the back substrate.

Further, in another image display device according to the present invention, in the above-mentioned constitution, a plurality of pairs of getter supports may preferably be formed and the respectively flange portion of the plurality of pairs of getter supports may preferably be fixed by way of a sealing member.

Further, in another image display device according to the present invention, in the above-mentioned constitution, an exhaust hole may preferably be formed in the bottom surface portion of the room member and an exhaust pipe may preferably be connected to the exhaust hole.

The present invention is not limited to the above-mentioned respective constitutions and the constitution described in the embodiments described later, and various modifications can be made without departing from the technical concept of the present invention.

According to the present invention, it is possible to obtain the high degree of vacuum by effectively activating the non-volatile getter and hence, it is possible to obtain extremely advantageous effects that a lifetime is prolonged and image performance is enhanced thus realizing a highly reliable image display device having high quality.

### BRIEF DESCRIPTION OF THE DRAWINGS

FIG. 1 is a schematic plan view showing the constitution of an embodiment 1 of an image display device according to the present invention;

FIG. 2 is an enlarged cross-sectional view of an essential part showing the constitution of the image display device of FIG. 1;

FIG. 3 is a plan view showing the constitution of a getter device shown in FIG. 2 as viewed from the direction indicated by an arrow A;

FIG. 4A and FIG. 4B are plan views explaining the structure of getter supports shown in FIG. 2 and FIG. 3;

FIG. 5 is an enlarged cross-sectional view of an essential part showing the schematic constitution of an electron-emission-type image display device of an embodiment 2 of the image display device according to the present invention;

FIG. 6 is a plan view showing the constitution of a getter device shown in FIG. 5 as viewed from the direction indicated by an arrow A;

FIG. 7 is a plan view of an essential part showing the constitution of a back substrate of the image display device according to the present invention;

FIG. 8 is a plan view of an essential part showing the constitution of a face substrate of the image display device according to the present invention; and

FIG. 9 is an enlarged cross-sectional view of an essential part showing the constitution of a phosphor screen formed on the face substrate of the image display device according to the present invention.

### DESCRIPTION OF THE PREFERRED EMBODIMENTS

Hereinafter, specific modes for carrying out the invention of the present invention are explained in detail in conjunction with the drawings showing the embodiments.

### Embodiment 1

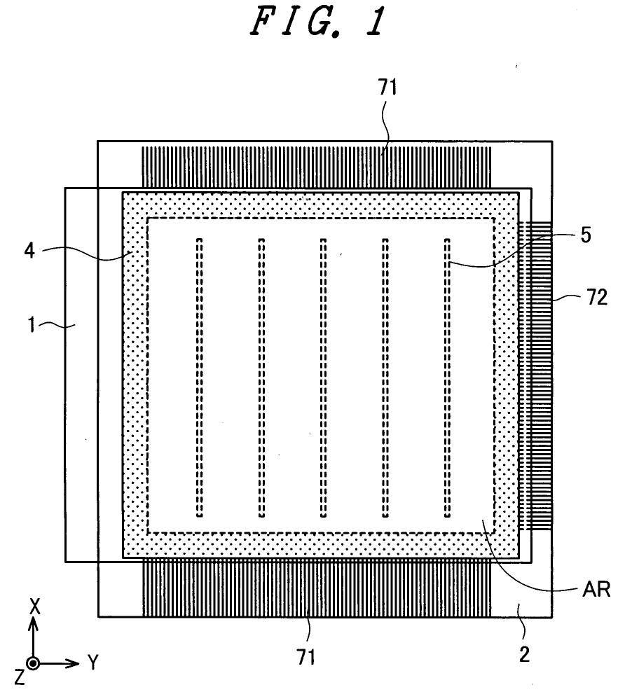

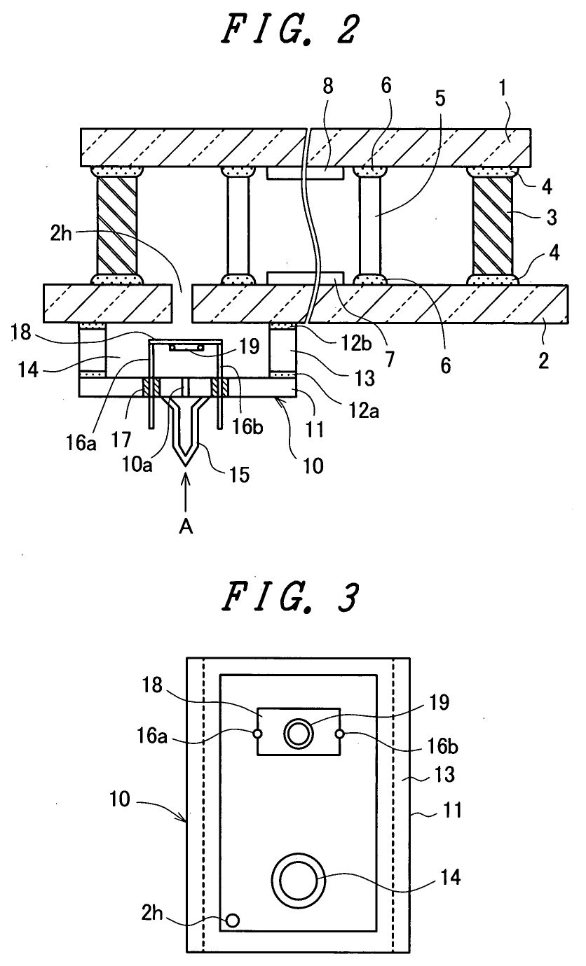

FIG. 1 is a plan view of an essential part explaining the schematic constitution of an electron-emission-type image display device of an embodiment 1 of the image display device according to the present invention, and FIG. 2 is an enlarged cross-sectional view of the essential part of FIG. 1. In FIG. 1 and FIG. 2, numeral 1 indicates a face substrate made of a light transmitting glass plate material, and numeral 2 indicates aback substrate made of, in the same manner as the face substrate 1, a light transmitting glass or ceramic plate material such as alumina. The face substrate 1 and the back substrate 2 are formed of an insulation substrate having a plate thickness of approximately 3 mm, for example.

Numeral 3 indicates a support frame as a support body which is formed by cutting a formed body made of glass or a frit glass plate material, by assembling the cut bodies into a frame shape and by adhering and fixing these cut bodies. The support frame 3 is arranged between the face substrate 1 and the back substrate 2 and is fixed by adhesion to peripheral portions of the face substrate 1 and the back substrate 2 using the sealing material 4 made of frit glass to hold a gap between the face substrate 1 and the back substrate 2 to a predetermined size, for example, approximately 3 mm.

Numeral 5 shown in FIG. 2 indicates plate-like spacers which constitute gap holding members. The spacers 5 are formed by cutting a thin glass plate or a thin ceramic plate material such as alumina having a thickness of approximately 0.1 mm or less having a width of approximately 3 mm (height size). As shown in FIG. 1, the plurality of spacers extend in one direction (X direction) substantially perpendicular to the substrate surface and are arranged and fixed to the face substrate 1 and the back substrate 2 using a fixing material 6 such as frit glass not shown in the drawing within the display region AR which is formed by being sandwiched between the face substrate 1 and the back substrate 2, and are arranged in parallel in another direction (Y direction). Further, the spacers hold the gap between the face substrate 1 and the back substrate 2 at the predetermined size in cooperation with the support frame 3.

Numeral 7 indicates a group of electron emission elements. The group of electron emission elements 7 is constituted of a plurality of electron emission sources. The electron emission source is constituted of a cathode, a control electrode and the like. A large number of electron emission sources are arranged on the back substrate 2 at a predetermined interval. The cathodes are connected to a cathode line. A plurality of cathode lines are arranged on an inner surface of the back substrate 2 in a state that the cathode lines extend in one direction (Y direction) and are arranged in another direction (X direction). End portions of the respective cathode lines are pulled out to two sides of the back substrate 2 outside of the hermetically sealed portion as cathode-line lead lines 71.

The cathode lines (image data lines) are formed by a vapor deposition method or the like, for example, or are formed by printing a silver paste which is prepared by mixing low-melting-point glass exhibiting insulation property into conductive silver particles having a particle size of approximately 1 to 5 μm as a thick film and by baking the silver paste at a temperature of approximately 600° C., for example.

Further, the control electrodes are connected to the scanning lines, while the scanning lines are arranged above the cathode lines in a state that the scanning lines are electrically insulated from the cathode lines. End portions of the scanning lines are pulled out to another one side of the back substrate 2 outside the hermetically sealed portion as scanning-line lead lines 72.

Further, the groups of electron emission elements 7 which are arranged on the back substrate 2 at the predetermined interval are formed of a metal-insulator-metal (MIM) type electron emission element, an element having the electron emission structure which makes use of an electric emission phenomenon based on a quantum tunneling effect (also referred to as a surface conduction type electron source), a diamond film, a graphite film, carbon nanotubes or the like.

Numeral 8 indicates an image forming member. The image forming member 8 is formed of a phosphor film, a metal back film which is applied to the phosphor film, a black matrix (BM) film and the like and is arranged on an inner surface of the face substrate 1 to face the electron emission element group 7 formed on the back substrate 2 in an opposed manner.

Numeral 10 indicates a getter device mounted on a back surface (outer surface) side of the back substrate 2. The getter device 10 is formed in a state that the getter device 10 is communicated with an exhaust hole 2h which is formed in a portion of the back substrate 2 excluding the region AR (electron source forming region) and is hermetically sealed. Accordingly, the inside of the getter device 10 has the degree of vacuum substantially equal to the degree of vacuum of the inside of the above-mentioned vacuum envelope. Here, when the display device is a large-sized display device panel, a plurality of getter devices 10 having the same structure is mounted on the display device. However, in this embodiment, one getter device is explained.

FIG. 3 is a plan view explaining the constitution of the getter device 10 shown in FIG. 2 as viewed from a back side (a direction indicated by an arrow A). In the getter device 10 shown in FIG. 3, one end side of a getter room frame body 13 is hermetically sealed to a peripheral portion of a getter room face plate 11 in a state that a sealing material 12a is interposed therebetween thus forming a room member. Further, another end side of the getter room frame body 13 is hermetically sealed to the back surface of the back substrate 2 in a state that a sealing material 12b is interposed therebetween thus forming a getter room 14.

Further, in a bottom surface portion of the getter room face plate 10, an exhaust hole 10a is formed, and an exhaust pipe 15 for exhausting a gas in the inside of the getter room 14 and the vacuum envelope to a predetermined degree of vacuum is connected to the exhaust hole 10a by hermetically joining. Here, the getter room 14 has sizes of, for example, approximately 50 mm in the longitudinal direction, approximately 40 mm in the lateral direction, and approximately 5.4 mm in the vertical direction.

Further, two through holes are formed in the getter room face plate 11 at a predetermined interval. Electrodes 16a, 16b formed of, for example, a stainless-steel-made rod material, are respectively inserted in these through holes. A sealing material 17 which has a coefficient of thermal expansion approximately equal to a coefficient of thermal expansion of the getter room face plate 11 and is made of, for example, a nickel (Ni)-chromium (Cr) material is sealed in the through holes, and the sealing material 17 fixes the electrode and hermetically seals the through holes. Further, both ends of the getter support 18 made of an Ni—Cr material are fixedly joined to the one ends of a pair of electrodes 16a, 16b in the inside of the getter room 14 using a means such as welding, for example. Another-end sides of the pair of electrodes 16a, 16b are projected to the outside from the getter room face plate 11 and function as power supply terminals. A getter assembly is constituted of the getter material, the getter support and the electrodes.

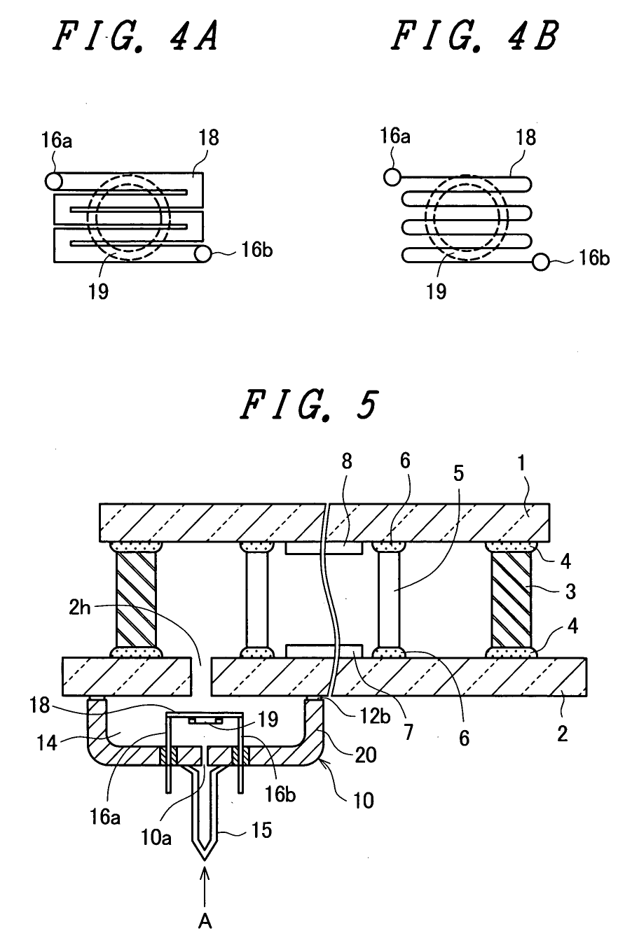

Further, the structure of the getter support 18 may preferably be formed in a shape with which the getter support 18 can acquire high thermal conductivity. For example, as shown in FIG. 4A which is a plan view, the getter support 18 may also be formed in a zigzag shape by forming notches in the Ni—Cr plate material. Further, as shown in a plan view in FIG. 4B, a Ni—Cr wire material may also be used for the getter support 18. Further, the getter support 18 may be formed by forming the Ni—Cr linear material into a helical shape. Further, on the getter support 18, a non-volatile getter 19 is fixedly arranged by joining using a means such as a resistance welding method or using a conductive adhesive material. As the non-volatile getter 19, the structure which fills the non-volatile getter 19 in a container where a foreign substance is hardly generated or the plate-like structure may be adopted.

Here, in the fixing structure of the non-volatile getter 19, with respect to a mounting position of the non-volatile getter 19 in the vertical direction, it is important to adjust an electrode lengths of the pair of electrodes 16a, 16b so that the non-volatile getter 19 is arranged between the back substrate 2 and the inner surface of the getter room face plate 11 in a state that the non-volatile getter 19 is brought into contact with neither the back substrate 2 nor the inner surface of the getter room face plate. Further, another-end sides of the pair of electrodes 16a, 16b are projected to the outside from the getter room face plate 11 to function as power supply terminals and hence, it is necessary to set a projecting length of the electrodes 16a, 16b to, for example, approximately 1 mm or more.

In the getter device 10 having the above-mentioned structure, the getter support 18 is heated by connecting an external power source to the pair of electrodes 16a, 16b which projects to the outside from the getter room face plate 11 and hence, due to the radiation of heat of the getter support 18, the non-volatile getter 19 is simultaneously heated and activated.

Due to such constitution, the non-volatile getter 19 is fixedly arranged using the pair of electrodes 16a, 16b and hence, in exhausting a gas during an exhaust step or at the time of exhausting a gas when the panel is turned on, it is possible to easily activate the non-volatile getter 19.

In the image display device, the envelope is sealed after the inside of the envelope is exhausted. The degree of vacuum in the envelope immediately after the sealing is approximately 10⁻³ to 10⁻⁴ Pa. The degree of vacuum in the envelope can be increased to approximately 10⁻⁵ to 10⁻⁶ Pa due to the activation of the non-volatile getter 19 after the sealing. Further, in the getter activation step, after sealing, a power source is supplied from the another-end sides of the pair of electrodes 16a, 16b and hence, the getter 19 is heated and activated. Due to the activation of the getter 19, a gas which intrudes into the inside of the getter room 14 through the exhaust hole 2h formed in the back substrate 2 is adsorbed to the getter 19 in the inside of the getter room 14. In this manner, the gas in the inside of the vacuum envelope is decreased to a quantity which does not impair or damage an image display.

Further, in the image display device having the above-mentioned constitution, the gas can be exhausted from the getter room 14 through the exhaust pipe 15 which is mounted on the bottom surface portion of the getter device 10 by hermetic joining and can tip off a distal end thereof and hence, it is possible to minimize the mounting number of the exhaust holes 2h formed in the back substrate 2. Accordingly, a possibility that the degree of vacuum is deteriorated attributed to leaking of the gas can be decreased.

### Embodiment 2

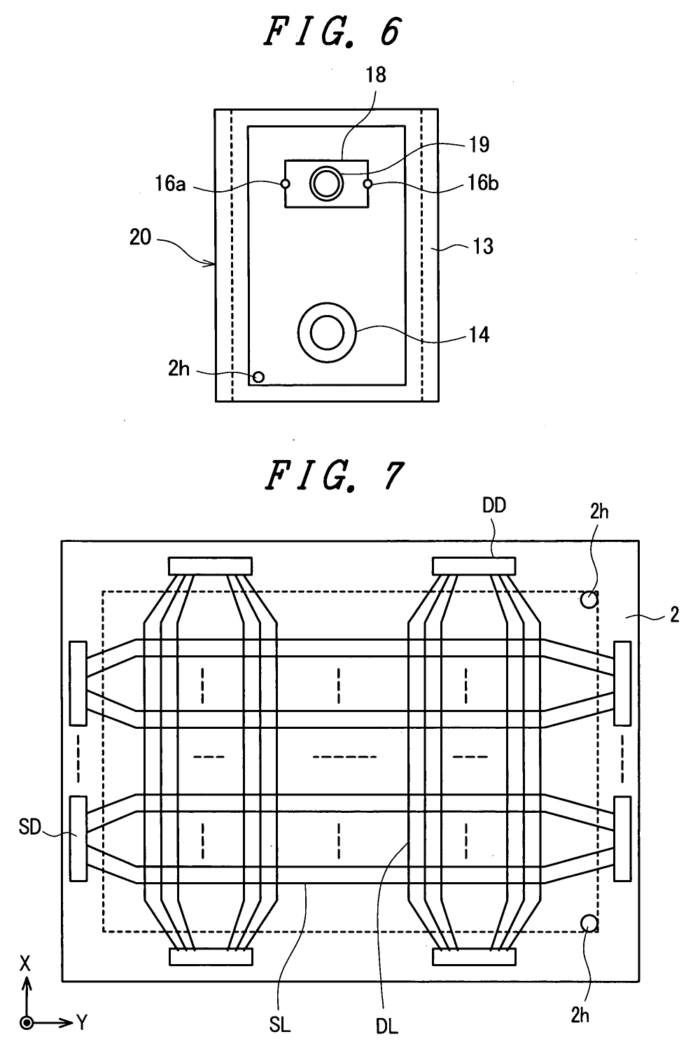

FIG. 5 is an enlarged cross-sectional view of an essential part explaining the schematic constitution of an electron-emission-type image display device of an embodiment 2 of the image display device according to the present invention, and FIG. 6 is a plan view for explaining the structure of a getter device 10 shown in FIG. 5 as viewed from a back side (direction indicated by an arrow A), and parts identical with the parts shown in the above-mentioned drawings are given the same symbols and the explanation thereof is omitted. The constitution shown in FIG. 5 differs from the constitution shown in FIG. 2 in that a getter room of the getter device 10 is constituted of a hermetic container 20 which is integrally formed in a cup shape. Also with the provision of such a constitution, it is possible to obtain exactly the same advantageous effects as the advantageous effects of the above-mentioned embodiment 1.

In the image display device having the above-mentioned structure, electrons emitted from respective electron sources of the electron emission element group 7 formed on the back substrate 2 advance in the direction toward the image forming member 8 to which an anode voltage is applied, pass through a metal back layer (anode) and impinge on a phosphor layers thus allowing the phosphor to emit light. By allowing the phosphors to emit light, a desired display can be performed on an image screen. In general, a color pixel consisting of red (R), green (G), blue (B) is formed of a group constituted of three unit pixels.

Here, the above-mentioned respective embodiments have been explained with respect to the case that the shape of the room member has the rectangular box shape or the cup shape. However, the present invention is not limited to such shapes and the room member may be formed in various kinds of shapes such as a bowl-shape.

FIG. 7 is a plan view of an essential part of the back substrate which constitutes the image display device according to the present invention as viewed from the inner side thereof. In FIG. 7, on a first surface (main surface) of the back substrate 2 which is preferably made of glass or a ceramic material, the a plurality of data lines (also referred to as cathode lines) DL which extends in the first direction (Y direction) and is arranged in parallel in the second direction (X direction) which intersects the first direction and a plurality of scanning lines SL which extends in the second direction (X direction) and is arranged in parallel in the first direction (Y direction) which intersects the second direction are formed. At intersecting portions between the data lines DL and the scanning lines SL which are arranged in a matrix array or in the vicinity of the intersection portions, the electron emission sources are formed.

The scanning lines SL have one ends thereof connected to a scanning driver SD, while the data lines DL have one ends thereof connected to a data driver DD. The face substrate is, in the drawing, arranged to face the back substrate 2 in an opposed manner along a broken line portion. The face substrate and the back substrate 2 are adhered to each other along outer peripheries of counter regions, and an inner gas is exhausted thus sealing the display device. On the other hand, on a second surface (back surface) of the back substrate 2, the above-mentioned getter device is arranged in a state that the getter device is communicated with the through hole 2h.

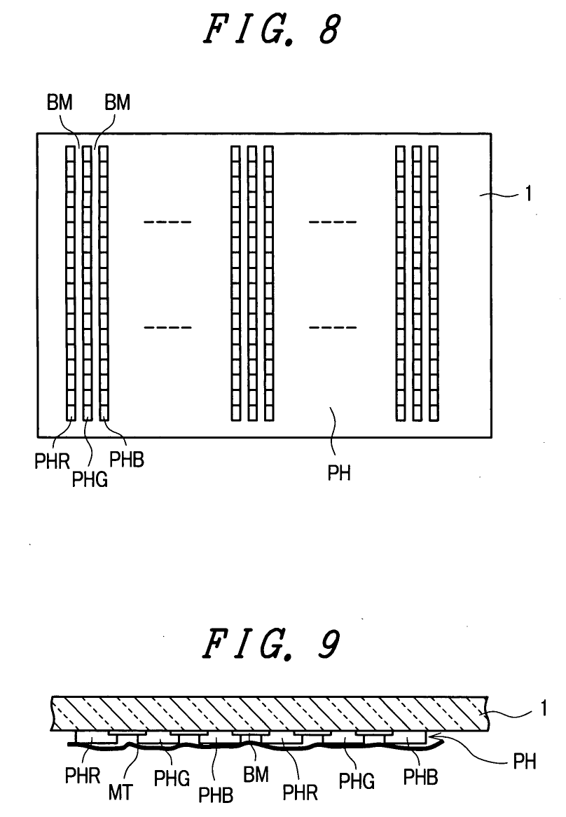

FIG. 8 is a plan view of an essential part of the face substrate which constitutes the image display device according to the present invention as viewed from the inner side thereof. In FIG. 8, a phosphor screen PH which includes red phosphor layers PHR, green phosphor layers PHG and blue phosphor layers PHB are formed on the inner surface (main surface) of the face substrate 1 made of a light transmitting glass material along the longitudinal direction of the plurality of data lines DL shown in FIG. 7. Further, on the phosphor screen PH, a black matrix film BM which partitions the respective red phosphor layers PHR, the green phosphor layers PHG and the blue phosphor layers PHB is formed.

FIG. 9 is an enlarged cross-sectional view of the phosphor screen PH formed on the inner surface of the face substrate 1. In FIG. 9, the red phosphor layers PHR, the green phosphor layers PHG and the blue phosphor layers PHB which constitute the phosphor screen PH are formed so as to cover a portion of the black matrix film BM. Further, a metal back film MT which effectively reflects light emitted from the respective red phosphor layers PHR, green phosphor layers PHG and blue phosphor layer PHB is formed on the phosphor screen PH.

Further, the above-mentioned embodiments are applicable to an electron-emission-type display device which includes phosphors and a black matrix on an inner surface of an image display device and also includes a face substrate which forms an anode on back surfaces of phosphors and the black matrix.

What is claimed is:

1. An image display device comprising a vacuum envelope in which a back substrate on which a plurality of electron emission sources are formed and a face substrate on which an anode and phosphors are formed are arranged with a predetermined gap therebetween and a space defined between the back substrate and the face substrate is hermetically sealed, wherein
a room member which forms a getter room communicated with the vacuum envelope is joined to an external surface of the back substrate, a getter assembly is arranged in the inside of the getter room, the getter assembly includes a non-volatile getter material, a getter support which fixes the getter material and heats the getter material, and a pair of electrodes which is pulled out to the outside through the room member, wherein the getter support is fixed between the pair of electrodes.

2. An image display device according to claim 1, wherein the getter room is communicated with the inside of the vacuum envelope via a through hole formed in the back substrate.

3. An image display device according to claim 1, wherein the room member includes an exhaust hole formed in a bottom surface portion and an exhaust pipe is connected to the exhaust hole.

4. An image display device according to claim 1, wherein the getter material is arranged between an outer surface of the back substrate and a surface of the room member which is arranged to face the outer surface of the back substrate.
